(19) United States
(12) Patent Application Publication
(10) Pub. No.: US 2024/0358579 A1
(43) Pub. Date: Oct. 31, 2024

(54) MASSAGE DEVICE AND MASSAGE UNIT

(71) Applicant: FAMILY INADA CO., LTD., Osaka (JP)

(72) Inventor: Nichimu INADA, Osaka (JP)

(21) Appl. No.: 18/770,524

(22) Filed: Jul. 11, 2024

Related U.S. Application Data
(63) Continuation of application No. PCT/JP2022/037534, filed on Oct. 7, 2022.

(30) Foreign Application Priority Data
Feb. 3, 2022 (JP) 2022-015532
Sep. 8, 2022 (JP) 2022-143254

(51) Int. Cl. A61H 7/00

(52) U.S. Cl. CPC A61H 7/004; A61H 7/007; A61H 2201/0149; A61H 2201/1215; A61H 2201/1623

(57) ABSTRACT

A massage device includes a backrest part that supports a back of a seated user, a first massage unit disposed inside the backrest part to be movable in a height direction of the seated user and performing a massage operation on the back of the user from the backrest part, and a second massage unit disposed in each of one side and the other side of the backrest part in a right-left direction and performing a massage operation on an upper arm side part excluding the back of the user. The second massage unit includes a pressing member that presses the upper arm side part of the seated user, and a mechanism that causes the pressing member to perform the massage operation including a two-dimensional operation in a plane intersecting a pressing direction. The mechanism is disposed to avoid space where the first massage unit is present.

### CROSS-REFERENCE TO RELATED APPLICATIONS

This is a bypass continuation of International PCT Application No. PCT/JP2022/037534, filed on Oct. 7, 2022, which claims priority to Japanese Patent Application No. 2022-015532, filed on Feb. 3, 2022 and Japanese Patent Application No. 2022-143254 filed Sep. 8, 2022, which are incorporated by reference herein in their entirety.

### BACKGROUND OF THE INVENTION

### Field of the Invention

The present disclosure relates to a massage device and a massage unit.

### Background Art

For example, JP2011-000419A (hereinafter, referred to as “Patent Document 1”) discloses a massage machine including a rubbing unit including a pair of rubbing parts that perform a rubbing massage on a body site of a treatment target person and a rubbing drive part that drives the rubbing part. In the massage machine, the rubbing part includes a pair of first rubbing parts disposed on both sides of the body site and reciprocating in a direction along a side surface of the body site, and a pair of second rubbing parts disposed on a back surface of the body site and reciprocating in a direction along the back surface of the body site and a direction intersecting the back surface.

### SUMMARY OF THE INVENTION

A manual skill of the massage includes a light rubbing method for lightly rubbing a target site with a hand, for example, a palm light rubbing method for lightly rubbing the target site with a palm, a kneading method for kneading the target site with the hand, and for example, a palm kneading method for kneading the target site with the palm. In a massage device in which a massage unit that performs a massage on a back of a user from an inside of a backrest part that supports the back of the user is disposed inside the backrest part, in some cases, even the massage device may need to perform a massage close to the above-described manual skill on an upper arm side part of the user which is a so-called shoulder acupuncture point. Even in this case, the present disclosure aims to provide a massage device and a massage unit which can provide a massage close to a manual skill for an upper arm side part of a user.

According to an embodiment, there is provided a massage device including a backrest part that supports a back of a seated user, a first massage unit disposed inside the backrest part and configured to move in a height direction of the seated user to perform a massage operation on the back of the user from the backrest part, and one or more second massage units disposed on each of one side and the other side of the backrest part in a right-left direction, and configured to perform the massage operation on an upper arm side part excluding the back of the user. The one or more second massage units include one or more pressing members that press the upper arm side part of the seated user, and a mechanism that causes the pressing members to perform the massage operation including a two-dimensional operation in a plane intersecting a pressing direction of the pressing members. The mechanism is disposed to avoid space where the first massage unit is present.

According to an embodiment of the present invention, there is provided a massage unit of a massage device in which a back massage unit for performing a massage operation on a back of a seated user is disposed to be movable in a height direction of the seated user inside a backrest part for supporting the back of the seated user, the massage unit disposed to avoid space where the back massage unit is present in each of one side and the other side of the backrest part in a right-left direction, and performing the massage operation on an upper arm side part excluding the back of the user. The massage unit includes a pressing member that presses the upper arm side part of the seated user, a support member that receives rotation of an eccentric cam to operate the pressing member, and a support wall located on a side opposite to a pressing direction of the pressing member with respect to the pressing member, and receiving a reactive force of the pressing member. A guiding member is provided in one of an inside of the support wall or the support member, and a guided member is provided in the other of the inside of the support wall or the inside of the support member. The guiding member is a member that restricts a movement of the pressing member to be the massage operation including a two-dimensional operation in a plane intersecting the pressing direction.

Further details will be described as an embodiment described below.

### BRIEF DESCRIPTION OF THE DRAWINGS

FIG. 1 is a schematic configuration diagram of a massage device according to an embodiment.

FIG. 2 is a schematic view when the massage device according to the embodiment is viewed from above.

FIG. 3 is an exploded view when a shoulder massage unit provided in the massage device is viewed from an inside of the massage device.

FIG. 4 is an exploded view when the shoulder massage unit provided in the massage device is viewed from an outside of the massage device.

FIG. 5 is a view when the shoulder massage unit provided in the massage device is viewed from a side (inside) of a user seated on the massage device.

FIG. 6 is a schematic view of a structure of an inside of an outer case of the shoulder massage unit and an outside of a support member.

FIG. 7 is a view for describing a two-dimensional operation of the shoulder massage unit.

FIG. 8 is a view for describing a two-dimensional operation of the shoulder massage unit.

FIG. 9 is a view for describing a two-dimensional operation of the shoulder massage unit.

FIG. 10 is a functional block diagram of the massage device.

FIG. 11 is a flowchart illustrating an example of an operation of the massage device.

FIG. 12 is a view when a shoulder massage unit according to another embodiment which is provided in the massage device is viewed from the outside of the massage device.

FIGS. 13A to 13C are views when the shoulder massage unit according to another embodiment which is provided in the massage device is viewed from above, FIG. 13A is a view of a state before the outer case is moved, FIG. 13B is a view of a state after the outer case is moved, and 13C is a view of a state where the outer case is omitted from the state in FIG. 13B.

FIGS. 14A to 14C are views when the shoulder massage unit according to another embodiment which is provided in the massage device is viewed from the side (inside) of the user seated on the massage device.

### DETAILED DESCRIPTION OF THE INVENTION

Overview of massage device and massage unit
(1) A massage device according to an embodiment of the present invention includes a backrest part that supports a back of a seated user, a first massage unit disposed inside the backrest part and configured to move in a height direction of the seated user to perform a massage operation on the back of the user from the backrest part, and one or more second massage units disposed on each of one side and the other side of the backrest part in a right-left direction, and configured to perform the massage operation on an upper arm side part excluding the back of the user. The second massage units include one or more pressing members that press the upper arm side part of the seated user. A mechanism that causes the pressing members to perform the massage operation including a two-dimensional operation in a plane intersecting a pressing direction of the pressing members. The mechanism is disposed to avoid space where the first massage unit is present.

The mechanism of the second massage unit is disposed to avoid the space where the first massage unit is present. Therefore, the first massage unit can perform the massage operation on the back of the seated user without interfering with the second massage unit. In addition, the second massage unit is a massage unit that performs the massage operation on the upper arm side part excluding the back of the user. Therefore, even when the first massage unit is located at the same height as that of the second massage unit in the height direction of the user, the first massage unit can perform the massage operation on the back of the user, separately from the massage operation performed on the upper arm side part of the user by the second massage unit.

The two-dimensional operation indicates an operation having components in two directions of a first direction and a second direction in a plane intersecting the pressing direction. The second massage unit performs the operation including the two-dimensional operation in association with the pressing. Therefore, while a target site is pressed, the massage can be performed on the target site by using a light rubbing method for lightly rubbing the target site with a hand, for example, a palm light rubbing method for lightly rubbing the target site with a palm, a kneading method for kneading the target site with the hand, and for example, a palm kneading method for kneading the target site with the palm. In this manner, it is possible to provide a massage close to a manual skill.
(2) Preferably, the mechanism includes one or more motors configured to drive the one or more second massage units, and a conversion mechanism that converts rotation of the motor into the massage operation. In this manner, for example, as the conversion mechanism, the second massage unit can perform the operation including the two-dimensional operation by using the rotation of the eccentric cam.
(3) Preferably, the one or more motors include a first motor for driving the one or more second massage units on one side and a second motor for driving the one or more second massage units on the other side. In this manner, the mechanism of the second massage unit on one side and the mechanism of the second massage unit on the other side can be easily disposed to avoid the space where the first massage unit is present.
(4) Preferably, the two-dimensional operation includes operating components of the backrest part in a front-rear direction and a longitudinal direction. In this manner, the massage of the second massage unit can be performed as a massage operation close to a manual skill, such as a palm light rubbing method for rubbing the target site with the palm of the hand and a palm kneading method for kneading the target site with the palm of the hand.
(5) Preferably, the two-dimensional operation includes a first movement of moving forward from a first position to a second position located in a front of the backrest part and a second movement of moving rearward from the second position to the first position. A first trajectory during the first movement and a second trajectory during the second movement are different from each other. In this manner, the massage of the second massage unit can be performed as a massage operation close to a manual skill, such as a palm light rubbing method for rubbing the target site with the palm of the hand and a palm kneading method for kneading the target site with the palm of the hand.
(6) Preferably, the mechanism causes each of the pressing member of the second massage unit on the one side and the pressing member of the second massage unit on the other side to independently perform the massage operation. In this manner, the second massage unit on one side and the second massage unit on the other side can independently perform the massage operation.
(7) Preferably, the massage device further includes a controller that controls the mechanism. The controller is configured to control the mechanism such that the massage operation is performed by only the pressing member of one of the second massage unit on the one side or the second massage unit on the other side, in a state where the pressing members of the second massage unit on the one side and the second massage unit on the other side are pressed in the pressing direction. In this manner, a massage close to a manual skill can be provided for a required side target site.
(8) Preferably, the massage device further includes a controller configured to control the mechanism to alternately use the second massage unit on the one side and the second massage unit on the other side such that the operation is performed by only the pressing member of one of the second massage unit on the one side or the second massage unit on the other side, in a state where the pressing members of the second massage unit on the one side and the second massage unit on the other side are pressed in the pressing direction. In this manner, it is possible to provide the massage close to the manual massage for the required side target site, and it is also possible to provide an effective massage since the second massage unit that performs the operation and the second massage unit on an opposite side that does not perform the operation are also in a pressed state.
(9) Preferably, the controller is configured to determine the massage operation to be performed on the user. The determination process includes causing one or both of the second massage unit on the one side and the second massage unit on the other side to perform the massage operation. The controller is configured to control the mechanism such that the massage operation is performed by only the pressing member of the second massage unit on the one side or the second massage unit on the other side according to the determination or intensity of the massage operation of the pressing member of the second massage unit on the determined side is stronger than intensity of the operation of the second massage unit on the other side.
(10) According to an embodiment, there is provided a massage unit of a massage device in which a back massage unit for performing a massage operation on a back of a seated user is disposed to be movable in a height direction of the seated user inside a backrest part for supporting the back of the seated user, the massage unit disposed to avoid space where the back massage unit is present in each of one side and the other side of the backrest part in a right-left direction, and performing the massage operation on an upper arm side part excluding the back of the user. The massage unit includes a pressing member that presses the upper arm side part of the seated user, a support member that receives rotation of an eccentric cam to operate the pressing member, and a support wall located on a side opposite to a pressing direction of the pressing member with respect to the pressing member, and receiving a reactive force of the pressing member. A guiding member is provided in one of an inside of the support wall or the support member, and a guided member is provided in the other of the inside of the support wall or the inside of the support member. The guiding member is a member that restricts a movement of the pressing member to be the massage operation including a two-dimensional operation in a plane intersecting the pressing direction.

The two-dimensional operation indicates an operation having components in two directions of the first direction and the second direction in a plane intersecting the pressing direction. The guided member is guided by the guiding member. In this manner, the rotation of the eccentric cam is converted into the operation having the components in two directions of the first direction and the second direction in a plane intersecting the pressing direction of the pressing member. In this manner, the pressing member performs a two-dimensional operation. The two-dimensional operation is performed by the pressing member. In this manner, while the target site is pressed, the massage can be performed on the target site by using a light rubbing method for lightly rubbing the target site with a hand, for example, a palm light rubbing method for lightly rubbing the target site with a palm, a kneading method for kneading the target site with the hand, and for example, a palm kneading method for kneading the target site with the palm. In this manner, it is possible to provide a massage close to a manual skill.
(11) Preferably, the guided member is a member having a protruding shape with respect to the guiding member. The guiding member includes a protruding part that blocks a relative movement of the guiding member, and a recessed part surrounded by the protruding part and in which the guiding member is relatively movable. The recessed part has each length in a first direction and a second direction to allow the relative movement in the first direction and the second direction in the intersecting plane. In this manner, the pressing member performs a two-dimensional operation.

### Examples of Massage Device and Massage Unit

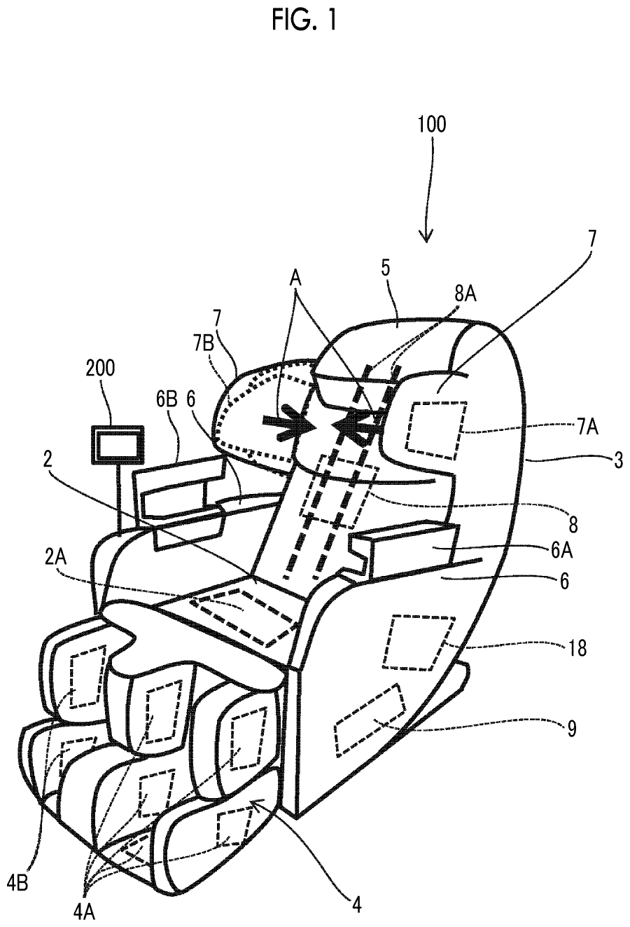

FIG. 1 is a schematic configuration diagram of a massage device 100 according to the present embodiment. The massage device 100 is a device that provides a massage by applying a stimulus to a user's body, and as an example, may be a chair type that is used by the user in a seated state, that is, a massage chair. As another example, the massage device 100 may be a foot massage machine, a shoulder massage machine, or the like. In the following examples, the massage device 100 is the massage chair.

With reference to FIG. 1, the massage device 100 mainly includes a seat part 2 on which the user is seated, a backrest part 3 on which the user leans, which can be reclined in a rear part of the seat part 2, a footrest 4 provided to be vertically swingable in a front part of the seat part 2 and supporting lower limbs of the user, a pillow part 5 provided on an upper front surface of the backrest part 3 and supporting a head and/or a neck of the user, armrest parts 6 (armrest) on both right and left sides of the seat part 2, and side wall parts 7 on both right and left sides of the backrest part 3. The seat part 2, the backrest part 3, the footrest 4, the pillow part 5, the armrest part 6, and the side wall part 7 function as body support parts that support a body site which is a part of the user's body.

A plurality of massage units which are operation mechanisms for performing the massage operation on the user's body are provided at various locations of the body support parts 2 to 7. The massage unit is driven by a drive mechanism to perform the massage associated with pressing on body sites supported by the body support parts.

Specifically, a thigh massage unit 2A for mainly performing the massage operation on a thigh is provided in the seat part 2. A mechanical massage unit 8 (first massage unit) for mainly performing the massage operation on a waist from a neck is provided in the backrest part 3. Foot massage units 4A and 4B for mainly performing the massage operation on a calf and a sole are provided on right and left sides in the footrest 4. Arm massage units 6A and 6B for mainly performing the massage operation on an arm are provided on the right and left sides in the armrest part 6. Shoulder massage units 7A and 7B (second massage units) for mainly performing the massage operation on a position referred to as a “shoulder pit” on a shoulder to an upper arm side are provided on the right and left sides in the side wall part 7. In addition, a pump unit 9 is provided below the seat part 2.

The mechanical massage unit 8 is an operation mechanism for a massage operation for performing a kneading operation and/or a tapping operation. The mechanical massage unit 8 is disposed inside the backrest part 3, and performs the massage on an upper user's body from a rear side (back surface). The mechanical massage unit 8 is a movable unit that can move in the height direction by moving on a guide rail 8A disposed in the height direction (up-down direction) of the user. A plurality of (one in the present embodiment) mechanical massage units 8 may be provided along the height direction.

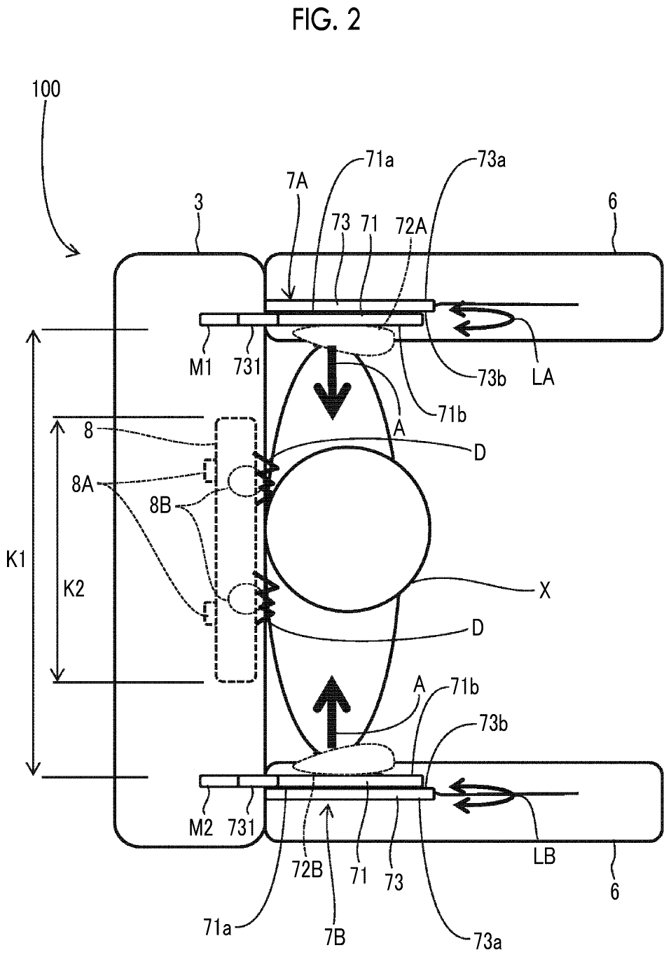

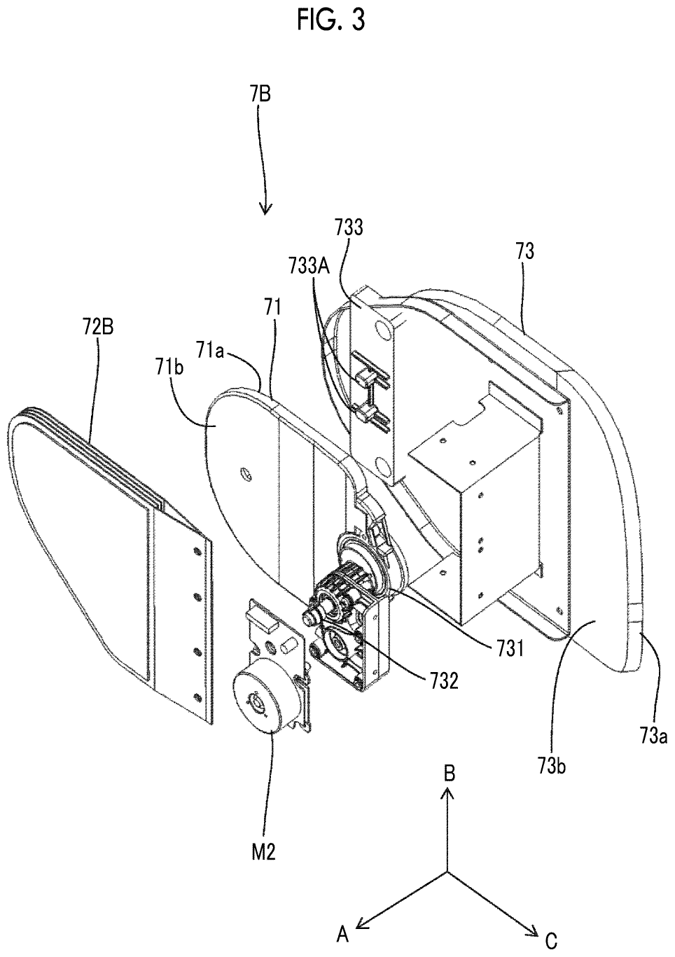

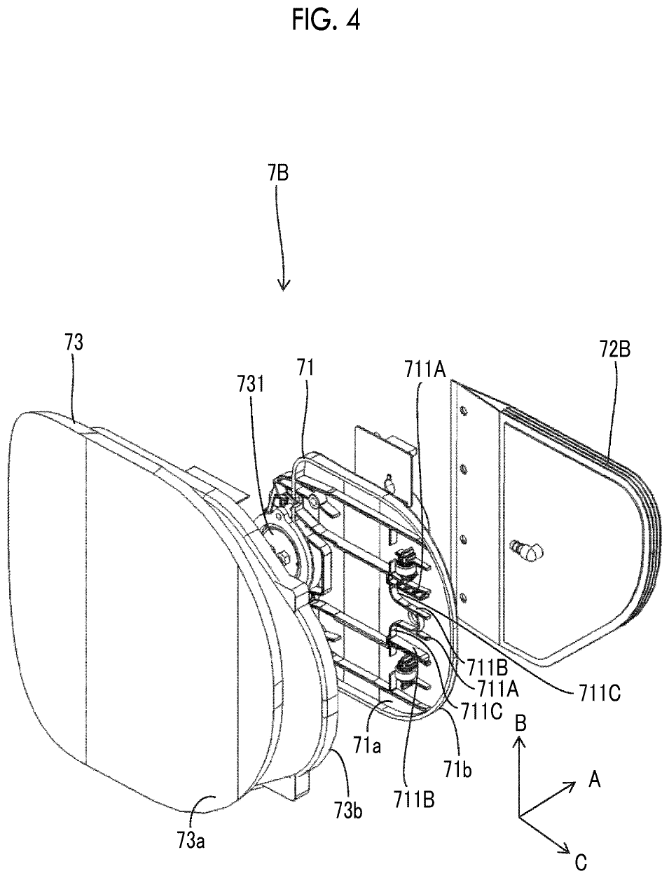

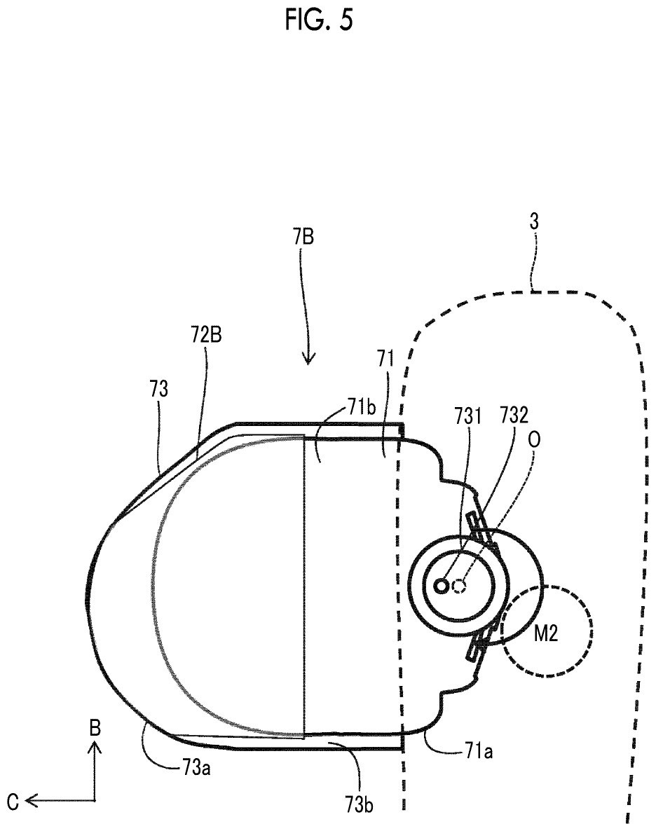

FIGS. 2 to 5 are views for describing the shoulder massage units 7A and 7B. FIG. 2 is a schematic view when the massage device 100 is viewed from above, and is a view illustrating schematic structures of the shoulder massage units 7A and 7B and the mechanical massage unit 8. FIGS. 3 and 4 are exploded views of the shoulder massage unit 7B. FIG. 3 is a view when viewed from the inside of the massage device 100, and FIG. 4 is a view when from the outside of the massage device 100. FIG. 5 is a view when the shoulder massage unit 7B is viewed from a user X side (inside) seated on the massage device 100.

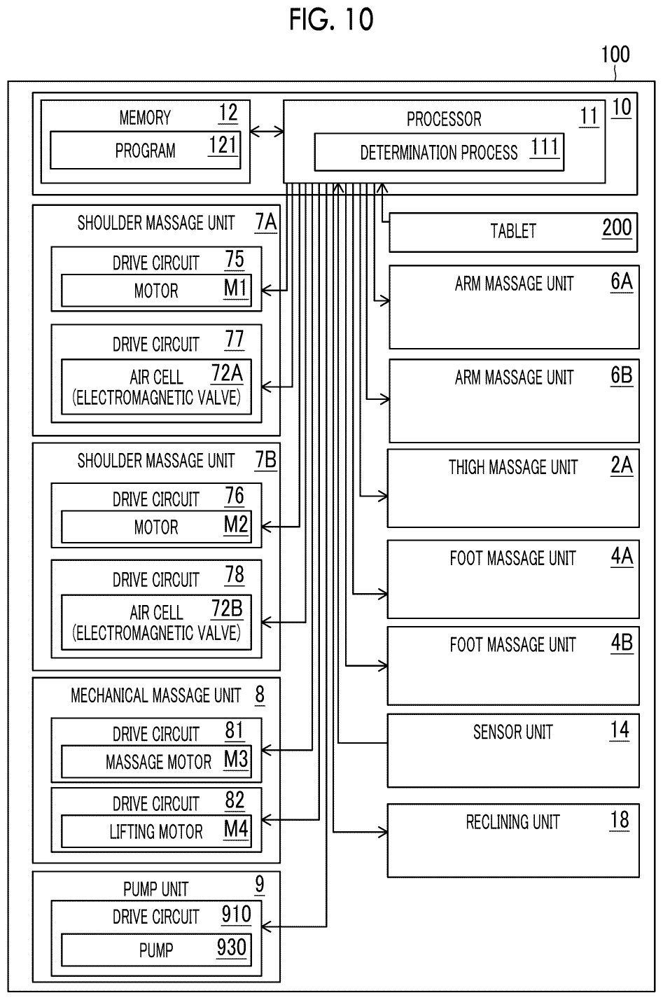

As a massage member, the mechanical massage unit 8 includes arms (not illustrated) forming a pair on the right and left sides, which are provided with treatment elements 8B in both upper and lower end parts. The mechanical massage unit 8 includes a massage motor M3 including one or a plurality of motors (FIG. 10). The massage motor M3 can be driven to perform a kneading operation of bringing the right and left treatment elements 8B close to and away from each other and a tapping operation of causing the right and left treatment elements 8B to alternately move forward to and rearward from the user side.

The mechanical massage unit 8 includes a lifting motor M4 (refer to FIG. 10) as a mechanism for operating the massage member. The mechanical massage unit 8 moves on a guide rail 8A (not illustrated) by a lifting mechanism (not illustrated) including a rack pinion or the like by driving the lifting motor M4. The guide rail 8A is provided to extend in the height direction inside the backrest part 3. Therefore, the mechanical massage unit 8 can be moved upward or downward along the height direction to change a position with respect to the body or to perform a rolling massage.

The shoulder massage units 7A and 7B are disposed on each of one side and the other side in the right-left direction of the backrest part 3 which is the body support part. Each of the shoulder massage units 7A and 7B includes air cells 72A and 72B as an example of the pressing members that press the body. The air cells 72A and 72B are air bags inflated and deflated by supplying and discharging air, and can press the user by supplying and discharging the air. A pressing direction A of the air cells 72A and 72B is an inward direction indicated by arrows in FIGS. 1 and 2.

Each of the shoulder massage units 7A and 7B has a mechanism that causes the pressing member to perform the massage operation including a two-dimensional operation in a plane intersecting the pressing direction. As an example, the mechanism that causes the pressing member to perform the operation includes a support member 71 and an outer case 73. A position of the outer case 73 is fixed to the backrest part 3. The outer case 73 includes an outer surface 73a on a side far from the seated user X, and an inner surface 73b on a side of the seated user X, which are parallel to a plane intersecting the pressing direction A. For example, the outer case 73 is formed of a hard material such as a urethane resin.

The support member 71 is located inside the outer case 73. The support member 71 includes an outer surface 71a on a side far from the seated user X and an inner surface 71b on a side of the seated user X, which are parallel to a plane intersecting the pressing direction A. The support member 71 is disposed such that the outer surface 71a is in contact with the inner surface 73b of the outer case 73. The support member 71 is provided to be movable with respect to the outer case 73.

The air cells 72A and 72B are located inside the support member 71, and are disposed to be in contact with the inner surface 71b of the support member 71. The air cells 72A and 72B are provided to be moved integrally with the support member 71.

As an example, the mechanism that causes the pressing member to perform the operation includes an eccentric cam 731. The support member 71 performs an operation including two-dimensional operations LA and LB in a plane parallel to a plane intersecting the pressing direction A in response to the rotation of the eccentric cam 731, and in association with the operation, the air cells 72A and 72B perform the operation including the two-dimensional operations LA and LB in the plane parallel to the plane intersecting the pressing direction A. The two-dimensional operation LA and LB indicate the operation having components in two directions of a first direction B and a second direction C in a plane parallel to the plane intersecting the pressing direction A (refer to FIGS. 3 and 4). As an example, the operations including the two-dimensional operations LA and LB are the two-dimensional operations LA and LB.

A reactive force generated by the pressing force of the air cells 72A and 72B in the pressing direction A is transmitted to the outer case 73 via the support member 71. The outer case 73 functions as a support wall that receives the reactive force generated by the pressing force of the air cells 72A and 72B.

As an example, the mechanism that causes the pressing member to perform the operation includes motors M1 and M2. As an example, the motors M1 and M2 are disposed inside the backrest part 3 by using an axis parallel to the pressing direction A as a rotary shaft. The motors M1 and M2 may be disposed outside the backrest part 3.

As an example, the eccentric cam 731 is a disk cam directly connected to the rotary shaft of the motors M1 and M2 or connected via a pulley (not illustrated). In response to the rotation of the motors M1 and M2, the eccentric cam 731 rotates around a rotation center 732 (refer to FIG. 5) by using the axis parallel to the pressing direction A as the rotary shaft. The rotation center 732 is provided eccentrically from a center O of the disk cam. In the drawing, the center O is illustrated in a virtual manner. In this manner, the eccentric cam 731 rotates in a plane parallel to the plane intersecting the pressing direction A.

The guiding member is provided in any one of the inner surface 73b of the outer case 73 and the outer surface 71a of the support member 71, and the guided member is provided in the other of the inner surface 73b of the outer case 73 and the outer surface 71a of the support member 71. The guided member is a member having a shape protruding toward the guiding member. The guiding member includes a recessed part in which the guided member is relatively movable and a protruding part that blocks relative movement of the guided member. The movement may be performed on the protruding part side or on the recessed part side.

A mechanism for causing the pressing members of the respective shoulder massage units 7A and 7B to perform the operation is disposed to avoid space where the mechanical massage unit 8 is present. Disposing the pressing members to avoid the space where the mechanical massage unit 8 is present indicates that a mechanism for operating the pressing member is not disposed in a space where the mechanical massage unit 8 may be present when the mechanical massage unit 8 moves along the guide rail 8A in the height direction of the user and performs the massage operation.

As an example, in the mechanisms that cause the pressing member to perform the operation, the members disposed inside the backrest part 3 such as the motor M1 and M2 and the eccentric cam 731 are disposed at an interval K1 in the right-left direction which is larger than a length K2 of the mechanical massage unit 8 in the right-left direction. Similarly, the member is disposed outside a range of the mechanical massage unit 8 moving in the height direction of the user along the guide rail 8A, in the height direction and the front-rear direction as well.

In this manner, the mechanical massage unit 8 can perform a massage operation D on the back of the seated user from the inside of the backrest part 3 without interfering with the shoulder massage units 7A and 7B. For example, as illustrated in FIG. 2, even when the mechanical massage unit 8 is moved in the height direction of the user and overlaps the shoulder massage units 7A and 7B in the height direction, the mechanical massage unit 8 can perform the massage operation D such as the kneading operation and the tapping operation on the back of the user at the position, and the massage operation close to the manual skill can be simultaneously is performed by the shoulder massage units 7A and 7B.

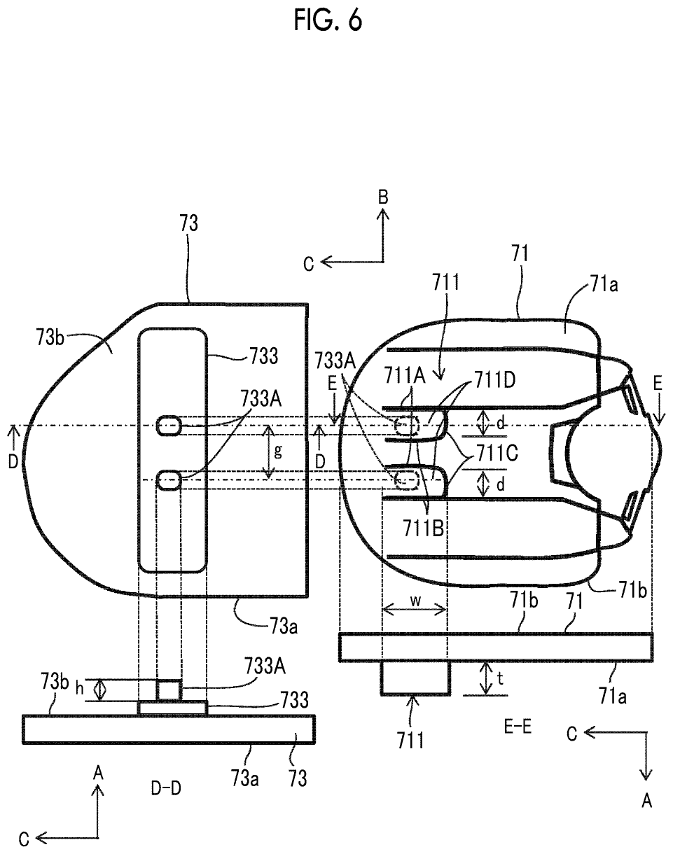

FIG. 6 is a schematic view when the outer case 73 is viewed from the inner surface 73b side and a schematic view when the support member 71 is viewed from the outer surface 71a side. In addition, FIG. 6 illustrates a cross-sectional view taken along line D-D for the outer case 73 and a cross-sectional view taken along line E-E for the support member 71. As an example, as illustrated in FIGS. 3, 4, and 6, a guiding member 711 is provided on the outer surface 71a of the support member 71, and a guided member 733A is provided on the inner surface 73b of the outer case 73. The guiding member 711 and the guided member 733A are respectively provided at positions overlapping each other on the outer surface 71a of the support member 71 and the inner surface 73b of the outer case 73 in a state where the support member 71 is disposed inside the outer case 73, as illustrated in FIGS. 3 and 4.

Specifically, with reference to FIG. 6, the guiding member 711 includes protruding parts 711A and 711B having a height t. The protruding parts 711A and 711B are provided on the surface of the outer surface 71a of the support member 71 at an interval d in the first direction B, and have at least a length w in the second direction C. The first direction B and the second direction C are directions in a plane intersecting the pressing direction A. Preferably, the first direction B is the up-down direction of the massage device 100. The second direction C is the front-rear direction with respect to the backrest part 3.

The guiding member 711 has a protruding part 711C having the height t. The protruding part 711C closes a space between the protruding part 711A and the protruding part 711B in the first direction B. The protruding part 711C closes at least one end of both ends between the protruding part 711A and the protruding part 711B in the second direction C. As an example, the protruding part 711C is provided to close end parts of the protruding part 711A and the protruding part 711B on a side close to the backrest part 3. In this manner, the guiding member 711 includes a recessed part 711D having the interval d in the first direction B and the length w in the second direction C, which are surrounded by the protruding parts 711A, 711B, and 711C having the height t.

Preferably, the guiding member 711 includes a plurality of sets of the protruding parts 711A and 711B. In FIG. 6, as an example, the guiding member 711 includes two sets of the protruding parts 711A and 711B with an interval g in the first direction B, and each one end is closed by the protruding part 711C. In this manner, the guiding member 711 includes two recessed parts 711D having the interval d in the first direction B and the length w in the second direction C, which are surrounded by the protruding parts 711A, 711B, and 711C, with the interval g in the first direction B. As another example, the guiding member 711 may include only one set of the protruding parts 711A to 711C, or may include three or more sets.

The guided member 733A has a protruding shape having a height h from the inner surface 73b of the outer case 73 in the pressing direction A. As an example, the guided member 733A is a projection having the height h which is provided in the base part 733 installed on the inner surface 73b of the outer case 73.

In the guided member 733A, the height h is lower than the height t (h<t), and a size in the first direction B is smaller than the size of the recessed part 711D. In this manner, as will be described later, when the support member 71 is disposed such that the outer surface 71a of the support member 71 is in contact with the inner surface 73b of the outer case 73, the guided member 733A is accommodated in the recessed part 711D, and the movement is blocked by the protruding parts 711A, 711B, and 711C. That is, the guided member 733A is movable only inside the recessed part 711D.

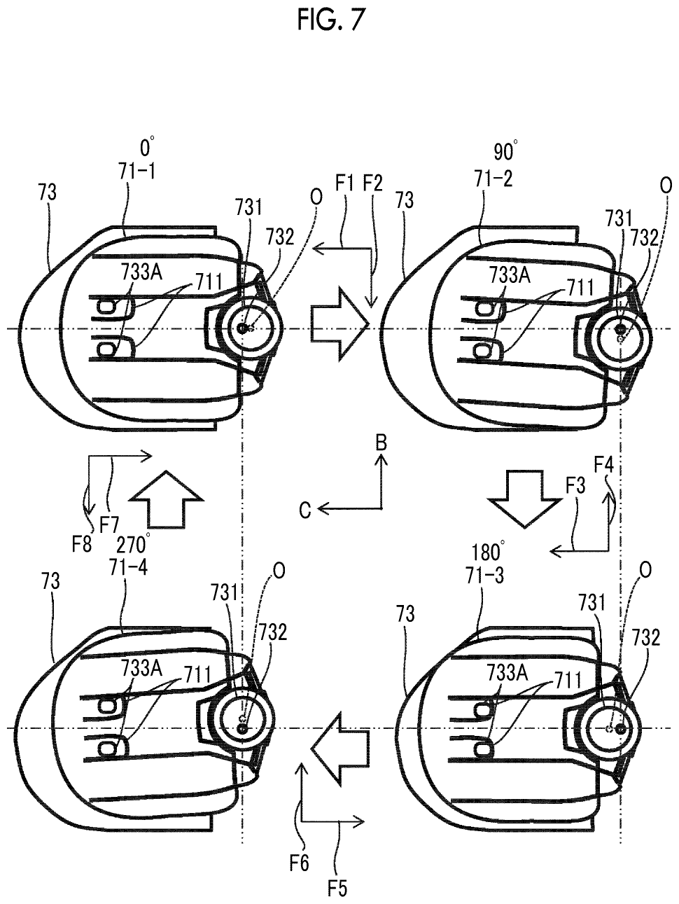

FIGS. 7 to 9 are views for describing two-dimensional operation LA and LB. In FIG. 7, positions of the support members 71 when viewed from the inside in a state where the eccentric cam 731 is rotated by 90° from a reference position (first position) are schematically illustrated by omitting the air cells 72A and 72B. Each of the support members 71-1, 71-2, 71-3, and 71-4 represents the positions of the support members 71 when a rotation angle around the rotation center 732 of the eccentric cam 731 is 0°, 90°, 180°, and 270°. The air cells 72A and 72B are integrated with the support member 71, and change the positions. The rotation angle indicates an angle formed with respect to the second direction C by the rotation center 732 and the center O of the disk cam.

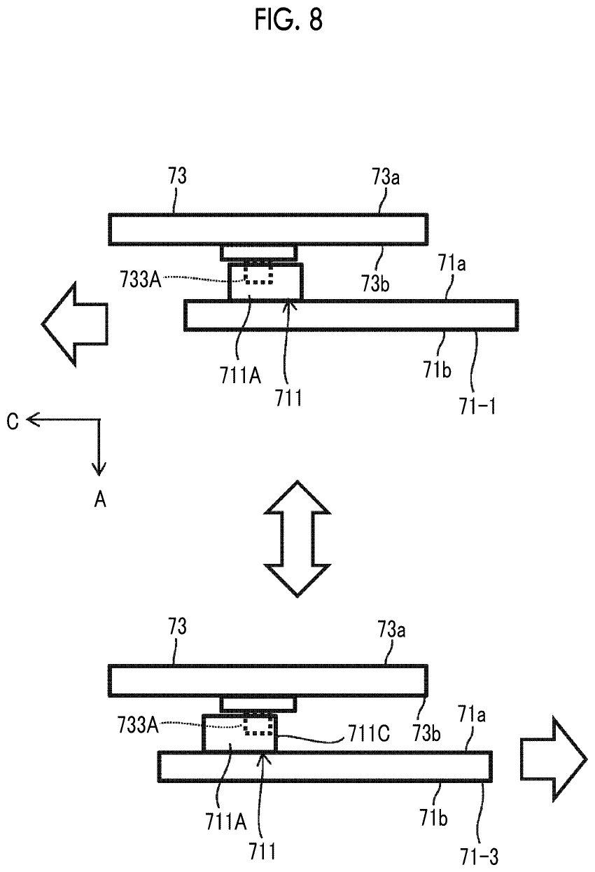

FIG. 8 is a schematic plan view when the support members 71-1 and 71-3 and the outer case 73 are viewed from above the massage device 100, when the reference position and the rotation angle of the support members 71-1 and 71-3 are 180°. With reference to FIG. 8, the support member 71 and the outer case 73 are disposed such that the guided member 733A is located inside the protruding part 711C of the guiding member 711.

The rotation of the eccentric cam 731 is transmitted to the support member 71 via a bearing such as a ball bearing. In this manner, the support member 71 moves in a plane parallel to the plane intersecting the pressing direction A. In this case, the support member 71 moves such that the inner guided member 733A of the outer case 73 moves inside the recessed part 711D of the outer guiding member 711 of the support member 71.

Specifically, with reference to FIGS. 7 and 8, when the rotation angle is changed from 0° to 90°, the protruding part 711A comes into contact with the guided member 733A. In this manner, the support member 71 moves while the movement in the first direction B is blocked. A range in which the support member 71 moves is a range in which the guided member 733A is located inside the recessed part 711D. As a result, the movement of the support member 71 is a two-dimensional operation having a leftward component F1 and a downward component F2 in FIG. 7.

When the rotation angle is changed from 90° to 180°, the protruding part 711B and the protruding part 711C come into contact with the guided member 733A. In this manner, the support member 71 moves while the movement in the first direction B and the movement in the second direction C are blocked. A range in which the support member 71 moves is a range in which the guided member 733A is located inside the recessed part 711D. As a result, the movement of the support member 71 is a two-dimensional operation having a leftward component F3 and an upward component F4 in FIG. 7.

When the rotation angle is changed from 180° to 270°, the protruding part 711B comes into contact with the guided member 733A. In this manner, the support member 71 moves while the movement in the first direction B is blocked. A range in which the support member 71 moves is a range in which the guided member 733A is located inside the recessed part 711D. As a result, the movement of the support member 71 is a two-dimensional operation having a rightward component F5 and an upward component F6 in FIG. 7.

When the rotation angle is changed from 270° to 360° (0°), the protruding part 711A and the protruding part 711C come into contact with the guided member 733A. In this manner, the support member 71 moves while the movement in the first direction B and the movement in the second direction C are blocked. A range in which the support member 71 moves is a range in which the guided member 733A is located inside the recessed part 711D. As a result, the movement of the support member 71 is a two-dimensional operation having a rightward component F7 and a downward component F8 in FIG. 7.

The support member 731 continuously rotates such that the support member 71 changes the positions in a plane parallel to the plane intersecting the pressing direction A in response to the rotation of the eccentric cam 731 in the order of the support member 71-1, the support member 71-2, the support member 71-3, the support member 71-4, and the support member 71-1. Therefore, the support member 71 repeatedly moves between the first position where the rotation angle is 0° and the second position where the rotation angle is 180°.

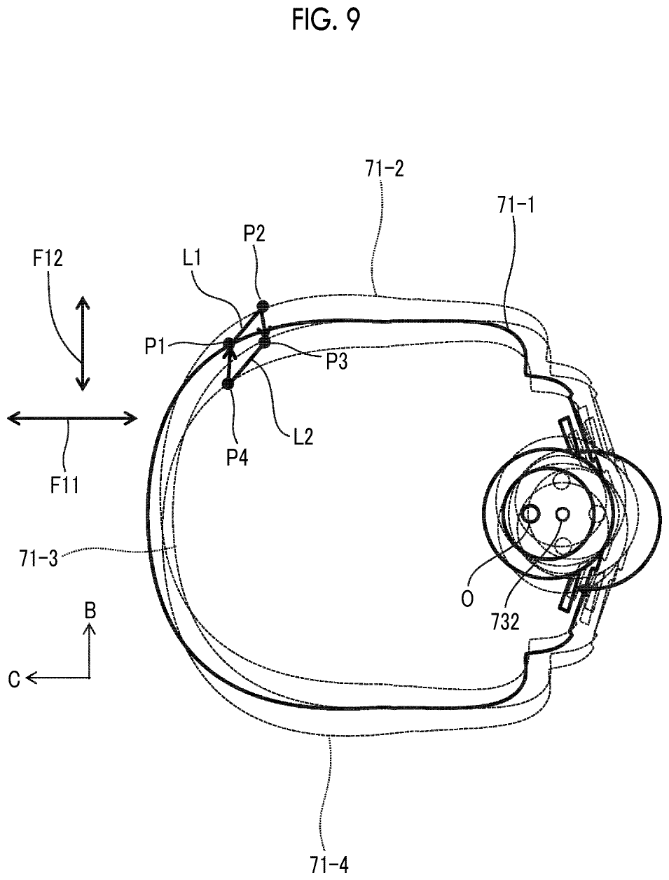

FIG. 9 is a view illustrating a positional relationship between the support members 71-1, 71-2, 71-3, and 71-4, and is a view illustrated by a dotted line of superimposing the support members 71-2, 71-3, and 71-4 on the support member 71-1 illustrated by a solid line. In FIG. 9, the same points P1, P2, P3, and P4 located on respective outer edges of the support members 71-1, 71-2, 71-3, and 71-4 are illustrated.

From FIGS. 7 to 9, the protruding part 711A and the protruding part 711B which have the length w in the second direction C are provided as the guiding member 711. In this manner, the rotation of the eccentric cam 731 which is transmitted to the support member 71 is converted into an operation in the second direction C. In addition, the protruding part 711C that closes the end parts of the protruding part 711A and the protruding part 711B which are disposed at the intervals d is provided as the guiding member 711. In this manner, in the first direction B, the rotation of the eccentric cam 731 which is transmitted to the support member 71 is converted into the operation in the first direction B. The eccentric cam 731 continuously rotates such that the rotation of the eccentric cam 731 is alternately converted into the operation in the first direction B and the operation in the second direction C. Therefore, the two-dimensional operation LA and LB performed by the support member 71 include a component F11 in the second direction C which is the front-rear direction of the backrest part 3, and a component F12 in the first direction B which is the longitudinal direction. In other words, the eccentric cam 731, the guiding member 711, and the guided member 733A function as a conversion mechanism that converts the rotation of the motors M1 and M2 into the two-dimensional operations LA and LB.

Specifically, with reference to FIG. 9, the rotation of the eccentric cam 731 is transmitted to the support member 71. Therefore, a first trajectory L1 of the same points P1, P2, and P3 in the support members 71-1, 71-2, and 71-3 when the rotation angle is changed from 0° to 180° and a second trajectory L2 of the same points P3, P4, and P1 in the support members 71-3, 71-4, and 71-1 when the rotation angle is changed from 180° to 360° (0°) are different from each other. That is, the two-dimensional operations LA and LB performed by the support member 71 are operations in which the first trajectory L1 during the movement from the first position to the second position and the second trajectory L2 during the movement from the second position to the first position are different from each other.

When the air cells 72A and 72B located inside the support member 71 are inflated with air, a two-dimensional pressing force is applied to a user X in addition to the pressing force in the pressing direction A which is generated by the inflation of the air cells 72A and 72B. Therefore, the guiding member 711 is a member that restricts the movement of the air cells 72A and 72B which are the pressing members to perform the two-dimensional operation in the plane intersecting the pressing direction A.

The guiding member 711 is restricted such that the support member 71 performs the two-dimensional operation LA and LB as illustrated in FIGS. 5 to 7. Therefore, while pressing the shoulder with the air cells 72A and 72B, the shoulder massage units 7A and 7B can perform a massage on the vicinity of the shoulder of the user by using a light rubbing method for lightly rubbing the target site with a hand, for example, a palm light rubbing method for lightly rubbing the target site with a palm, a kneading method for kneading the target site with the hand, and for example, a palm kneading method for kneading the target site with the palm.

As another example, the massage operation including the two-dimensional operations LA and LB may be a three-dimensional operation further including a component in the pressing direction A. In this case, as an example, the support member 71 is provided parallel to a plane intersecting the pressing direction A at an angle other than 90°. In addition, in this case, the mechanism for operating the pressing member includes a deflection angle cam or an eccentric deflection angle cam that rotates in response to the rotation of the motor M1 or M2, instead of the eccentric cam 731. In this manner, the support member 71 performs an operation having components in three directions of the first direction B, the second direction C, and the pressing direction A. As a result, the air cells 72A and 72B perform the massage operation having components in the three directions of the first direction B, the second direction C, and the pressing direction A.

FIG. 10 is a functional block diagram of the massage device 100. With reference to FIG. 10, the massage device 100 includes a control device 10. The control device 10 includes a computer including a processor 11 and a memory 12. The processor 11 is connected to each unit to control each unit. Some functions of the processor 11 may be realized by a processor (not illustrated) mounted on a tablet 200 (to be described later).

The memory 12 stores a program 121. The program 121 is a program for causing the processor 11 to control the massage operation of the massage device 100. The processor 11 executes the program 121 in accordance with an operation signal from the tablet 200 (to be described later). In this manner, the processor 11 functions as a massage controller.

The massage device 100 includes the shoulder massage units 7A and 7B which are massage units. Each of the shoulder massage units 7A and 7B includes the motor M1 and M2 including one or a plurality of motors. The motors M1 and M2 are examples of actuators that cause the shoulder massage units 7A and 7B to perform the massage operation, and are included in the drive mechanism that drives the massage units.

Each of the shoulder massage units 7A and 7B includes drive circuits 75 and 76 that drive the motors M1 and M2. The drive circuits 75 and 76 control the driving of the motors M1 and M2 in accordance with the control signals from the processor 11. Each of the shoulder massage units 7A and 7B includes the motors M1 and M2 and the drive circuits 75 and 76. Accordingly, the processor 11 can drive the motors M1 and M2 independently. As a result, the shoulder massage units 7A and 7B can be independently driven.

As an example, the processor 11 may control the drive circuits 75 and 76 such that only one of the shoulder massage units 7A and 7B performs the two-dimensional operation in a state where both the shoulder massage units 7A and 7B press the shoulders in the pressing direction A. In this manner, the massage can be performed on one side by only one of the shoulder massage units 7A and 7B.

As another example, the processor 11 may control the drive circuits 75 and 76 to alternatively drive the shoulder massage units 7A and 7B such that only one performs the two-dimensional operation in a state where one shoulder massage unit in the shoulder massage units 7A and 7B presses the shoulder in the pressing direction A. In this manner, the massage can be alternately performed on the right and left sides by each of the shoulder massage units 7A and 7B.

Each of the shoulder massage units 7A and 7B includes drive circuits 77 and 78. The drive circuits 77 and 78 drive electromagnetic valves for supplying and discharging the air from the pump unit 9 (to be described later) to and from the air cells 72A and 72B. The drive circuits 77 and 78 and the electromagnetic valves are examples of the actuators that cause the shoulder massage units 7A and 7B to perform the massage operation, and are included in a drive mechanism that drives the massage units. The drive circuits 77 and 78 control opening and closing of the electromagnetic valve in accordance with the control signal from the processor 11. In this manner, supplying and discharging the air to and from the air cells 72A and 72B are controlled.

The massage device 100 includes the pump unit 9. The pump unit 9 includes a pump 930 and a drive circuit 910 that controls the driving of the pump 930, and supplies and discharges the air to and from the air cell included in each massage unit. The pump 930 is an example of an actuator that operates the pump unit 9. The drive circuit 910 controls the driving of the pump 930 in accordance with the control signal from the processor 11, and controls supplying and discharging the air to and from the air cell.

The massage device 100 includes the mechanical massage unit 8 which is the massage unit. The mechanical massage unit 8 includes the massage motor M3. The massage motor M3 is an example of an actuator that causes the massage unit to perform the massage operation. The mechanical massage unit 8 includes a drive circuit 81 that drives the massage motor M3. The drive circuit 81 controls the driving of the massage motor M3 in accordance with the control signal from the processor 11.

The mechanical massage unit 8 includes the lifting motor M4. The lifting motor M4 is an actuator that causes the massage unit to perform the massage operation, and is an example of an actuator that moves the mechanical massage unit 8 along the guide rail 8A in the up-down direction. The mechanical massage unit 8 includes a drive circuit 82 that drives the lifting motor M4. The drive circuit 82 controls the driving of the lifting motor M4 in accordance with the control signal from the processor 11.

The mechanical massage unit 8 may include a sensor (not illustrated), and may be configured to obtain body type information of the user X by detecting that an arm reaches a predetermined swing position of the shoulder or the like. A signal indicating the predetermined position of the detected shoulder or the like is input to the processor 11. The processor 11 obtains a position of other sites (neck, back, waist, and the like) through calculation with the predetermined position as a reference, and detects the body type of the user X.

The massage device 100 includes arm massage units 6A and 6B, a thigh massage unit 2A, and foot massage units 4A and 4B, which are the massage units. Each of the massage units 6A, 6B, 2A, 4A, and 4B includes an air cell (not illustrated) as an example of the pressing member, and a drive circuit thereof. The drive circuit drives an electromagnetic valve for supplying and discharging the air from the pump unit 9 to and from the air cell. The drive circuit and the electromagnetic valve are examples of actuators that cause the massage units 6A, 6B, 2A, 4A, and 4B to perform the massage operation, and are included in a drive mechanism that drives the massage units. The drive circuit controls opening and closing of the electromagnetic valve in accordance with the control signal from the processor 11. In this manner, supplying and discharging the air to and from the air cell are controlled.

The massage device 100 includes a sensor unit 14 which is the massage unit. The sensor unit 14 includes a sensor (not illustrated) for detecting a degree of the massage operation or a state of the user. Specifically, the sensor detects an operation amount of the actuator, or detects an internal pressure of the air cell. Variations can be assigned to the massage operation by detecting the internal pressure of the air cell. Details will be described later. The sensor may be disposed in each of the massage units. A signal indicating a sensing result in the sensor unit 14 is input to the processor 11.

The massage device 100 includes a reclining unit 18 which is the massage unit. The reclining unit 18 is a unit that changes an angle of the backrest part 3 in accordance with the massage operation, and includes an actuator (not illustrated) and a drive circuit thereof for changing the angle. The drive circuit controls the driving of the actuator in accordance with the control signal from the processor 11.

The massage device 100 includes the tablet 200 as an example of an operation part that receives a user operation. The tablet 200 may be a device integrated with the massage device 100, or may be another device independent of the massage device 100. The tablet 200 receives an operation input of the user, and inputs an operation signal indicating the operation to the processor 11. The tablet 200 may output information in accordance with the control signal from the processor 11. The information output by the tablet 200 may be a display of an image on a display (not illustrated), may be an audio output from a speaker (not illustrated), or may be both of these.

The processor 11 functions as a massage controller by executing the program 121, and performs a determination process 111. The determination process 111 includes determining the massage operation to be performed on the user X. Determining the massage operation to be performed includes determining whether any of the shoulder massage units 7A and 7B performs the two-dimensional operation. In addition, determining the massage operation to be performed may include determining intensity or a time of the massage operation.

In the determination process 111, the processor 11 may use a sensing result from the sensor unit 14. For example, the processor 11 may calculate a stiffness degree, a body type, or the like of the user X from the sensing result from the sensor unit 14, and may determine the shoulder massage unit for performing the two-dimensional operation stored in advance in association with the stiffness degree, the body type, or the like, or may determine the intensity of the massage.

In the determination process 111, the processor 11 may use an operation signal from the tablet 200. For example, when the operation signal for instructing the massage is received by designating the shoulder massage units 7A and 7B, the processor 11 may determine the designated shoulder massage unit as the shoulder massage unit for performing the two-dimensional operation, or may determine the designated intensity as the intensity of the massage operation.

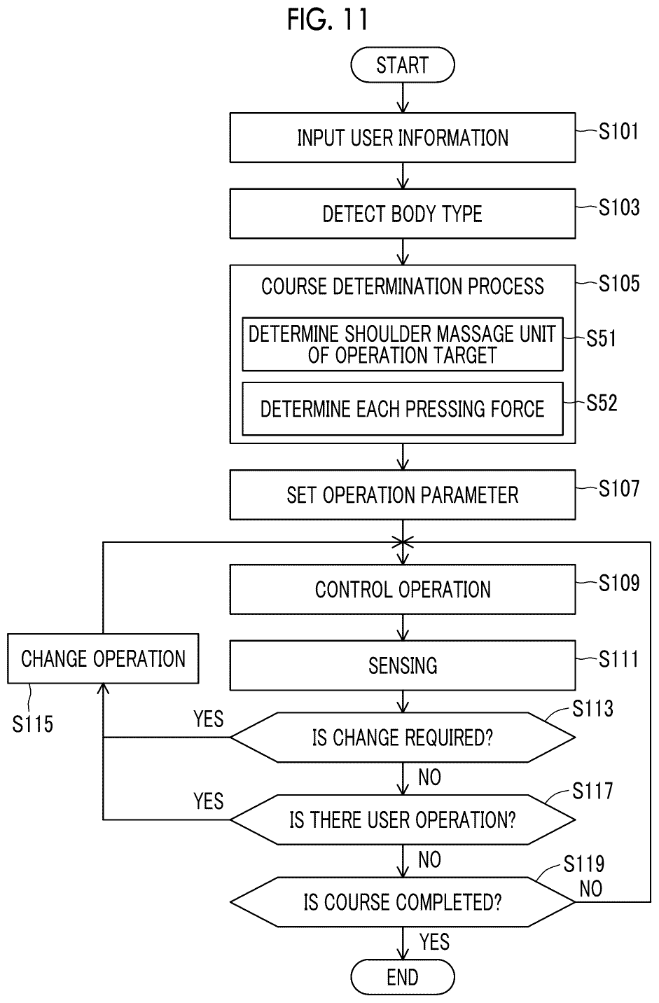

FIG. 11 is a flowchart illustrating an example of the operation of the massage device 100. The operation of FIG. 11 is an operation controlled by the control device 10. That is, the processor 11 executes the program 121 stored in the memory 12 in accordance with the operation signal from the tablet 200, and controls each of the massage units in accordance with the program 121.

First, with reference to FIG. 11, the processor 11 receives an input of user information for the user X of the massage device 100 from the tablet 200 or the like (Step S101). For example, the user information is an age group, a gender, or the like of the user X. In this manner, information relating to the provided massage can be stored in association with the user. As a result, for example, data that can be used for a proposal of the massage, billing, and the like can be constructed.

Next, the processor 11 detects the body type of the user X by operating the required massage unit (Step S103). For example, the processor 11 can detect the body type of the user X by activating the mechanical massage unit 8 to obtain the sensing result. In this manner, the processor 11 can use the body type of the user X in setting operation parameters subsequent thereto.

Next, the processor 11 determines a massage course, based on the body type of the user X, the operation signal from the tablet 200, and the like (Step S105). The massage course indicates one massage operation or a combination of a plurality of massage operations. A process of determining the massage course includes determining the shoulder massage unit for performing the two-dimensional operation (Step S51), determining the pressing force of the shoulder massage unit (Step S52), and the like.

In this manner, the two-dimensional operation can be performed by the required shoulder massage unit in the shoulder massage units 7A and 7B. Therefore, the two-dimensional operation can be performed by both the shoulder massage units 7A and 7B, and the two-dimensional operation can be performed by any one of the shoulder massage units 7A and 7B. In addition, the two-dimensional operation can be performed with different pressing forces by the shoulder massage unit 7A and the shoulder massage unit 7B.

For example, a case where the two-dimensional operation is performed by both the shoulder massage units 7A and 7B will be described. The shoulder massage units 7A and 7B are disposed to be symmetrical on the right and left sides in a plan view when the center of the backrest part 3 is set as a center line. That is, the motors M1 and M2 are disposed to face a direction in which the output shafts extending from the motors M1 and M2 face each other.

Therefore, when both the right and left motors M1 and M2 are rotated in the same direction (M1 forward rotation, M2 forward rotation, M1 reverse rotation, or M2 reverse rotation), the shoulder massage units 7A and 7B move in the direction in which both face each other. When the right and left motors M1 and M2 are rotated in different directions (M1 forward rotation, M2 reverse rotation, M1 reverse rotation, or M2 forward rotation), the shoulder massage units 7A and 7B move in the same direction.

For example, the motor M1 of the shoulder massage unit 7A is rotated in a forward direction, and the motor M2 of the shoulder massage unit 7B is rotated in a reverse direction. In this manner, the shoulder massage units 7A and 7B can perform two-dimensional operation in which the movement direction is the same direction. In addition, the motor M1 of the shoulder massage unit 7A is rotated in the forward direction, and the motor M2 of the shoulder massage unit 7B is rotated in the forward direction. In this manner, the shoulder massage units 7A and 7B can perform the two-dimensional operation in which the movement directions of the shoulder massage units 7A and 7B are different from each other. In addition, only the motor M1 or M2 of any one of the shoulder massage units 7A and 7B is rotated in the forward direction or in the reverse direction, and the other shoulder massage unit is stopped. In this manner, the massage can be performed on any one shoulder part of the right and left shoulder parts.

In addition, the sensor unit 14 detects the internal pressure of the air cell. In this manner, the operation of the shoulder massage units 7A and 7B can be more finely controlled. For example, the two-dimensional operation can be performed with different pressing forces by the shoulder massage unit 7A and the shoulder massage unit 7B.

Specifically, the internal pressure of the air cell 72A of the shoulder massage unit 7A and the internal pressure of the air cell 72B of the shoulder massage unit 7B are set to be different from each other (internal pressure of air cell 72A>internal pressure of air cell 72B, internal pressure of air cell 72A<internal pressure of air cell 72B). In this manner, the pressing force applied by the shoulder massage unit 7A and the pressing force applied by the shoulder massage unit 7B can be different from each other. That is, the massage can be performed with different pressing forces by the right and left shoulder massage units 7A and 7B.

In addition, when the setting of the detected internal pressure is configured to be changed as appropriate in response to a timing of the massage operation, the operation can be more finely controlled, and various massage operations can be performed.

For example, when the shoulder massage unit 7A is driven in a state where the internal pressure of the air cell 72A is low, a rubbing operation can be realized by the shoulder massage unit 7A and the air cell 72A. In addition, when the shoulder massage unit 7A is driven in a state where the internal pressure of the air cell 72A is high, a kneading operation can be realized by the shoulder massage unit 7A and the air cell 72A. In this way, a hybrid massage operation can be realized by the shoulder massage unit 7A and the air cell 72A.

As in the shoulder massage unit 7A, the shoulder massage unit 7B can realize the hybrid massage operation by combining the driving of the shoulder massage unit 7B and the internal pressure of the air cell 72B.

Hereinafter, the normal massage device is controlled. That is, the processor 11 sets an operation parameter required for the determined massage course (Step S107). In Step S107, the required operation parameter is set, based on the body type of the user X detected in Step S103, the operation signal from the tablet 200, or the like. For example, the operation parameter is a position of the massage, a pressing force of the air cell, or the like. In this manner, the operation amount of the required actuator is determined. As a result, it is possible to perform the massage operation corresponding to the body type of the user X or the user operation.

Next, the processor 11 controls the operation of the required massage unit to perform the massage in accordance with the determined massage course by using the set operation parameter (Step S109). In this manner, the massage operation is performed.

The processor 11 obtains a sensing result from the sensor of the sensor unit 14 during the massage operation (Step S111). The processor 11 changes the operation to be performed in accordance with the sensing result when necessary (YES in Step S113) (Step S115). In addition, even when the user operation is received from the tablet 200 (YES in Step S117), the processor 11 changes the operation to be performed in accordance with the user operation (Step S115).

The processor 11 repeats Steps S109 to S117 until the massage operation defined in the massage course is completed (NO in Step S119). When the massage operation defined in the massage course is completed (YES in Step S119), the processor 11 completes a series of controls.

In the above description, the shoulder massage units 7A and 7B are provided in the side wall part 7. However, the shoulder massage units 7A and 7B may be provided at other positions, instead of the side wall part 7 or in addition to the side wall part 7. The other positions may be located on each of one side and the other side of the body support part in the right-left direction, and for example, may be the footrest 4, the armrest part 6, or the like. In this manner, the massage can be similarly performed on other sites. While a target site is pressed, the massage can be performed on the target site by using a light rubbing method for lightly rubbing the target site with a hand, for example, a palm light rubbing method for lightly rubbing the target site with a palm, a kneading method for kneading the target site with the hand, and for example, a palm kneading method for kneading the target site with the palm.

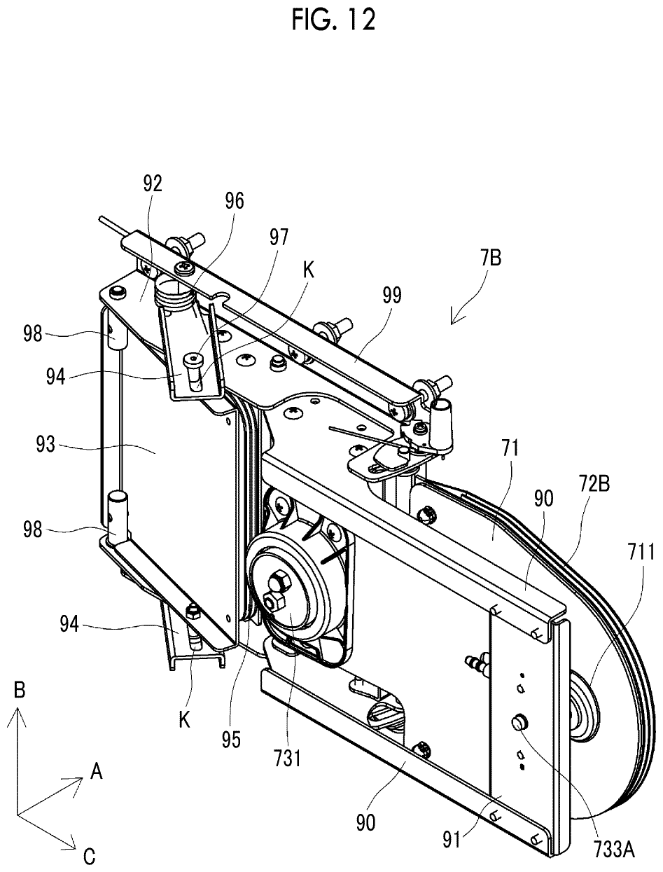

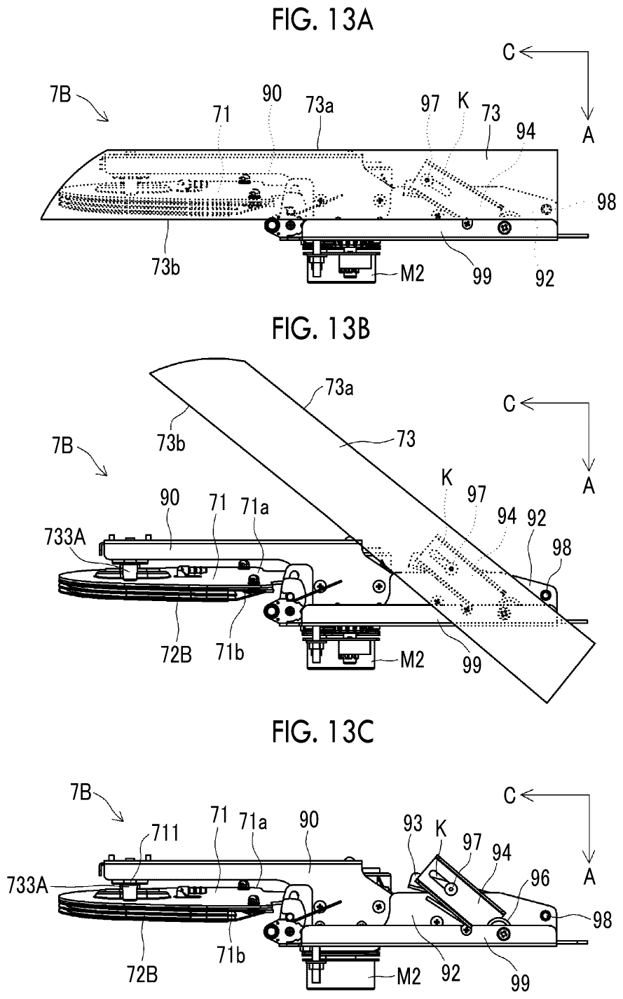

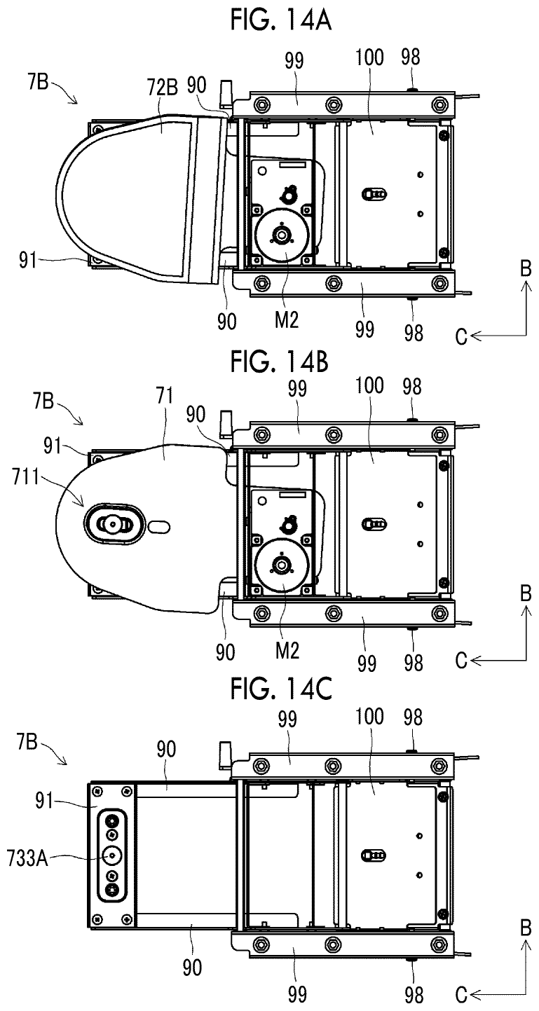

FIG. 12 is a view when the shoulder massage unit 7B according to another embodiment provided in the massage device 100 is viewed from the outside of the massage device 100. FIGS. 13A to 13C are views when the shoulder massage unit 7B according to another embodiment provided in the massage device 100 is viewed from above. FIG. 13A is a view of a state before the outer case 73 is moved, FIG. 13B is a view of a state after the outer case 73 is moved, and FIG. 13C is a view of a state where the outer case 73 is omitted from the state in FIG. 13B. FIG. 14 is a view when the shoulder massage unit 7B according to another embodiment provided in the massage device 100 is viewed from the side (inside) of the user seated on the massage device 100. The same reference numerals are assigned to members having the same configuration as that of the shoulder massage unit 7B according to the embodiment.

With reference to FIG. 12, the shoulder massage unit 7B according to another embodiment is different from the above-described embodiment in a configuration including a first frame body 90, a second frame body 91, and a third frame body 92 for attaching a main body of the shoulder massage unit including the air cell 72B, and a moving mechanism for moving the outer case 73. The first frame body 90 to the third frame body 92 are combined with each other.

The first frame body 90 is formed of a metal member extending in the front-rear direction. The first frame body 90 has different shapes on a front side and on a rear side. More specifically, the first frame body 90 has a bar-like shape in which the width in the right-left direction is the same from the front side to the vicinity of the center, and has a substantially lightning-like shape in which the width in the right-left direction gradually increases from the vicinity of the center toward the rear side.

A pair of the first frame bodies 90 is provided in the up-down direction. Specifically, the pair of first frame bodies 90 is provided in the up-down direction with a predetermined interval corresponding to the second frame body 91. The front side of the vicinity of the center of the first frame body 90 is formed in an L shape. Since the front side of the first frame body 90 is formed in the L-shape, the second frame body 91 can be fitted and fixed to an L-shaped groove. In addition, the first frame body 90 can be strengthened. The second frame body 91 is attached to the front side (more specifically, an L-shaped part formed in front of the first frame body 90) of the first frame body 90. The third frame body 92 is attached to the rear side of the first frame body 90.

The second frame body 91 is formed of a metal plate-shaped member extending in the up-down direction. The second frame body 91 is formed in a U-shape. Since the second frame body 91 is formed in the U-shape, the second frame body 91 can be strengthened. An upper end of the second frame body 91 is attached to the front side of the first frame body 90 located above. A lower end of the second frame body 91 is attached to the front side of the first frame body 90 located below. As illustrated in FIG. 14, one protruding-shaped guided member 733A that restricts the movement of the support member 71 is attached to the vicinity of the center of the second frame body 91. The guided member 733A is guided by an elongated hole as the guiding member 711 provided in front of the support member 71. In this manner, the rotation of the eccentric cam 731 is converted into an operation having components in two directions of the first direction and the second direction in a plane intersecting the pressing direction of the pressing member.

The third frame body 92 is formed of a metal plate-shaped member. The third frame body 92 is attached to be located between the first frame body 90 and a fixing frame 99. A pair of the third frame bodies 92 is provided in the up-down direction.

A moving mechanism is attached to both sides (both sides in the first direction B) of the third frame body 92. The outer case 73 can be moved in a direction away from the user X seated on the massage device 100 or in a direction closer to the user X by the moving mechanism.

A hole is provided on the rear side of the third frame body 92, and a swing shaft 98 is inserted into the hole. In addition, a link member 94 is attached to the rear side of the third frame body 92 at a position in front of the swing shaft 98. The front side of the third frame body 92 is connected to and attached to the rear side of the first frame body 90.

An air cell attachment plate 100 formed of a metal plate-shaped member formed in a C-shape is attached between the pair of third frame bodies 92 provided in the up-down direction (refer to FIG. 14). More specifically, the air cell attachment plate 100 is attached to the third frame body 92 to be inclined outward from the inside in the right-left direction in a plan view. A hole into which an air inlet/outlet of an air cell 95 is inserted is provided in the vicinity of the center of the air cell attachment plate 100, and the air cell 95 is attached to the air cell attachment plate 100. That is, the air cell attachment plate 100 has a function as a reactive force receiver when the air cell 95 is inflated.

As illustrated in FIG. 12, a support plate 93 is attached to the outer side of the air cell 95 in the right-left direction. The support plate 93 is a member formed of metal, and has a shape in which three sides excluding the front side are bent outward in the right-left direction. Each cutout is provided on the upper side and the lower side of the support plate 93. The swing shaft 98 is fitted into the cutout, and the support plate 93 is fixed to the swing shaft 98 by screwing. A link shaft 97 is attached to a side of the support plate 93. The link shaft 97 is inserted into a hole K provided in the link member 94.

That is, the support plate 93 can move in the right-left direction with the swing shaft 98 as a fulcrum, and a movement range thereof is restricted by the link shaft 97 and the hole K.

The end part of the link member 94 is attached with a double torsion spring 96. The link member 94 is always biased in a direction of the pressing direction A by a double torsion spring 96. The outer case 73 is attached to the link member 94.

When the air cell 95 is inflated, the support plate 93 swings around the swing shaft 98 as the fulcrum, and the link member 94 moves in a direction opposite to the pressing direction A. The link shaft 97 of the support plate 93 is inserted into the hole K of the link member 94. Therefore, the movement of the link member 94 and the movement of the support plate 93 are interlocked with each other, both of these move in a direction away from the user X seated on the massage device 100.

When the air cell is deflated, the link member 94 moves in the pressing direction A with the swing shaft 98 as the fulcrum due to an action of the double torsion spring 96. The link shaft 97 of the support plate 93 is inserted into the hole K of the link member 94. Therefore, the movement of the link member 94 and the movement of the support plate 93 are interlocked with each other, and both of these move in a direction closer to the user X seated on the massage device 100.

That is, the support plate 93, the link member 94, the air cell 95, the double torsion spring 96, the link shaft 97, and the swing shaft 98 are the moving mechanisms for moving the outer case 73.

The fixing frame 99 for attaching the shoulder massage unit 7B to the backrest part 3 is attached to a side (side in the pressing direction A) of the third frame body 92. The shoulder massage unit 7B can be attached to the backrest part 3 by screwing the fixing frame 99 and the backrest part 3 (in an example, three locations in the up-downward direction).

That is, the shoulder massage unit 7B is attached to the backrest part 3 via the fixing frame 99.

The present invention is not limited to the above-described embodiments, and various modifications can be made.

What is claimed is:

1. A massage device comprising:
a backrest part that supports a back of a seated user;
a first massage unit disposed inside the backrest part and configured to move in a height direction of the seated user to perform a massage operation on the back of the user from the backrest part; and
one or more second massage units disposed on each of one side and the other side of the backrest part in a right-left direction, and configured to perform the massage operation on an upper arm side part excluding the back of the user,
wherein the one or more second massage units include:
one or more pressing members that press the upper arm side part of the seated user, and
a mechanism that causes the pressing members to perform the massage operation including a two-dimensional operation in a plane intersecting a pressing direction of the pressing members, and
wherein the mechanism is disposed to avoid space where the first massage unit is present.

2. The massage device according to claim 1,
wherein the mechanism includes:
one or more motors configured to drive the one or more second massage units, and
a conversion mechanism that converts rotation of the motor into the massage operation.

3. The massage device according to claim 2,
wherein the one or more motors include:
a first motor for driving the one or more second massage units on the one side, and
a second motor for driving the one or more second massage units on the other side.

4. The massage device according to claim 1,
wherein the two-dimensional operation includes operating components of the backrest part in a front-rear direction and a longitudinal direction.

5. The massage device according to claim 1,
wherein the two-dimensional operation includes a first movement of moving forward from a first position to a second position located in a front of the backrest part and a second movement of moving rearward from the second position to the first position, and
wherein a first trajectory during the first movement and a second trajectory during the second movement are different from each other.

6. The massage device according to claim 1,
wherein the mechanism causes each of the pressing member of the second massage unit on the one side and the pressing member of the second massage unit on the other side to independently perform the massage operation.

7. The massage device according to claim 1, further comprising:
a controller configured to control the mechanism such that the massage operation is performed by only the pressing member of one of the second massage unit on the one side or the second massage unit on the other side, in a state where the pressing members of the second massage unit on the one side and the second massage unit on the other side are pressed in the pressing direction.

8. The massage device according to claim 1, further comprising:
a controller configured to control the mechanism to alternately use the second massage unit on the one side and the second massage unit on the other side such that the operation is performed by only the pressing member of one of the second massage unit on the one side or the second massage unit on the other side, in a state where the pressing members of the second massage unit on the one side and the second massage unit on the other side are pressed in the pressing direction.

9. The massage device according to claim 7,
wherein the controller is configured to determine the massage operation to be performed on the user by causing one or both of the second massage unit on the one side and the second massage unit on the other side to perform the massage operation, and
wherein the controller is configured to control the mechanism such that the massage operation is performed by only the pressing member of the second massage unit on the one side or the second massage unit on the other side according to the determination or intensity of the massage operation of the pressing member of the second massage unit on the determined side is stronger than intensity of the operation of the second massage unit on the other side.

10. A massage unit of a massage device in which a back massage unit for performing a massage operation on a back of a seated user is disposed to be movable in a height direction of the seated user inside a backrest part for supporting the back of the user, the massage unit being disposed to avoid space where the back massage unit is present in each of one side and the other side of the backrest part in a right-left direction, and performing the massage operation on an upper arm side part excluding the back of the user, the massage unit comprising:
a pressing member that presses the upper arm side part of the seated user;
a support member that receives rotation of an eccentric cam to operate the pressing member; and
a support wall located on a side opposite to a pressing direction of the pressing member with respect to the pressing member, and receiving a reactive force of the pressing member,
wherein a guiding member is provided in one of an inside of the support wall or the support member, and a guided member is provided in the other of the inside of the support wall or the support member, and
wherein the guiding member is a member that restricts a movement of the pressing member to be the massage operation including a two-dimensional operation in a plane intersecting the pressing direction.

11. The massage unit according to claim 10,
wherein the guided member is a member having a protruding shape with respect to the guiding member,
wherein the guiding member includes a protruding part that blocks a relative movement of the guided member, and a recessed part surrounded by the protruding part and in which the guided member is relatively movable, and
wherein the recessed part has a length in each of a first direction and a second direction to allow the relative movement in the first direction and the second direction in the intersecting plane.
